(19) United States
(12) Patent Application Publication
(10) Pub. No.: US 2018/0208431 A1
(43) Pub. Date: Jul. 26, 2018

(54) ELEVATOR VISUAL COMMUNICATION SYSTEM

(71) Applicant: OTIS ELEVATOR COMPANY, Farmington, CT (US)

(72) Inventors: Gerard Sirigu, Gien (FR); Aurelien Fauconnet, Isdes (FR)

(21) Appl. No.: 15/745,889

(22) PCT Filed: Jul. 22, 2015
(86) PCT No.: PCT/IB2015/001349

§ 371 Date: Jan. 18, 2018

(51) Int. Cl. B66B 3/00; B66B 5/00; B66B 5/02; G10L 15/26; H04M 3/51

(52) U.S. Cl. CPC B66B 3/008; B66B 5/0018; H04M 3/5116; G10L 15/265; B66B 5/02

(57) ABSTRACT

A visual communication system (28) for an elevator car (22) of an elevator system (20) includes a voice recognition module (34) configured to recognize a first voice communication (56) originating from a source (30) remotely located from the elevator car (22) and generate a text message (52). The text message is transmitted to a text display (36) located in the elevator car (22) for viewing by an elevator car passenger (24).

### BACKGROUND

The present disclosure relates to an elevator system, and more particularly, to a visual communication system of the elevator system.

Traditional elevators may be found in any structure having multiple levels or floors. Typically, and while in motion, the elevator car of an elevator confines the passengers within the elevator car space. When a floor destination is reached, doors of the elevator system will open allowing passengers to exit the elevator car. Reliable operation of an elevator may be reliant upon the surrounding structure which supports the elevator and/or a reliable power source that supplies electrical power for elevator operation (as two, non-limiting, examples). Failure of either, or for any variety of other reasons, may cause an unusual event that may confine the passenger to the elevator car for an undesired and extended period of time. Improved means to communicate with the passengers for at least the period of the unusual event, or confinement, is desirable.

### SUMMARY

A visual communication system for an elevator car of an elevator system according to one, non-limiting, embodiment includes a voice recognition module configured to recognize a first voice communication originating from a source remotely located from the elevator car, and generate a text message; and a text display disposed in the elevator car and configured to visually display the text message indicative of the first voice communication.

Additionally to the foregoing embodiment, the source is a human being.

In the alternative or additionally thereto, in the foregoing embodiment the system includes a battery for providing power to the text display and the voice recognition module.

In the alternative or additionally thereto, in the foregoing embodiment the system includes a voice communication module configured to receive the first voice communication from the source and transmit to the voice recognition module.

In the alternative or additionally thereto, in the foregoing embodiment the system includes a speaker located in the elevator car and configured to receive the first voice communication from the voice communication module and audibly transmit the first voice communication into the elevator car.

In the alternative or additionally thereto, in the foregoing embodiment the system includes a microphone located in the elevator car and configured to receive a second voice communication from a passenger in the elevator car and transmit the second voice communication to the source.

In the alternative or additionally thereto, in the foregoing embodiment, the voice recognition module and the voice communication module are carried by the elevator car.

In the alternative or additionally thereto, in the foregoing embodiment the system includes a wireless phone line facilitating transmission of the first voice communication from the source to the voice communication module, and wherein the voice communication module includes an auto dialer configured to initiate communications.

In the alternative or additionally thereto, in the foregoing embodiment the system includes a battery for providing back-up power to the text display and the voice recognition module and the voice communication module.

In the alternative or additionally thereto, in the foregoing embodiment the system includes a speaker located in the elevator car and configured to receive the first voice communication from the voice communication module and audibly transmit the first voice communication into the elevator car; a microphone located in the elevator car and configured to receive a second voice communication from a passenger in the elevator car and transmit the second voice communication to the source; and a communication line facilitating transmission of the first and second voice communications between the source and the voice communication module, and wherein the voice recognition module is carried by the elevator car.

In the alternative or additionally thereto, in the foregoing embodiment, the voice communication module is carried by the elevator car.

In the alternative or additionally thereto, in the foregoing embodiment the system includes a battery constructed and arranged to provide back-up power to the text display, the voice recognition module, and the voice communication module.

A method of operating a visual communication system for an elevator car of an elevator according to another, non-limiting, embodiment includes producing a first voice communication by a source located remotely from the elevator car; converting the first voice communication to a text message; displaying the text message on a display in the elevator car; and reading of the text message by the passenger.

Additionally to the foregoing embodiment, an initiation of an unusual event causes undesirable confinement of a passenger in the elevator car.

In the alternative or additionally thereto, in the foregoing embodiment the method includes audibly transmitting the first voice communication into the elevator car.

In the alternative or additionally thereto, in the foregoing embodiment the method includes speaking a second voice communication by the passenger in response to the text message; receiving the second voice communication by a microphone in the elevator car; and transmitting the second voice communication to the source.

In the alternative or additionally thereto, in the foregoing embodiment, the first and second voice communications are electronically transmitted via a voice communication module.

In the alternative or additionally thereto, in the foregoing embodiment, the first voice communication is generated into the text message via a voice recognition module.

In the alternative or additionally thereto, in the foregoing embodiment the method includes providing back-up power to the display, the voice communication module and the voice recognition module by a battery.

In the alternative or additionally thereto, in the foregoing embodiment the method includes auto dialing a communication link between the source and the passenger upon occurrence of the unusual event.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of an elevator system with parts broken away to show internal detail and having a visual communication system as one, non-limiting, exemplary embodiment of the present disclosure;

FIG. 2 is a block diagram of the visual communication system; and

FIG. 3 is a flow chart of a method of operating the visual communication system.

### DETAILED DESCRIPTION

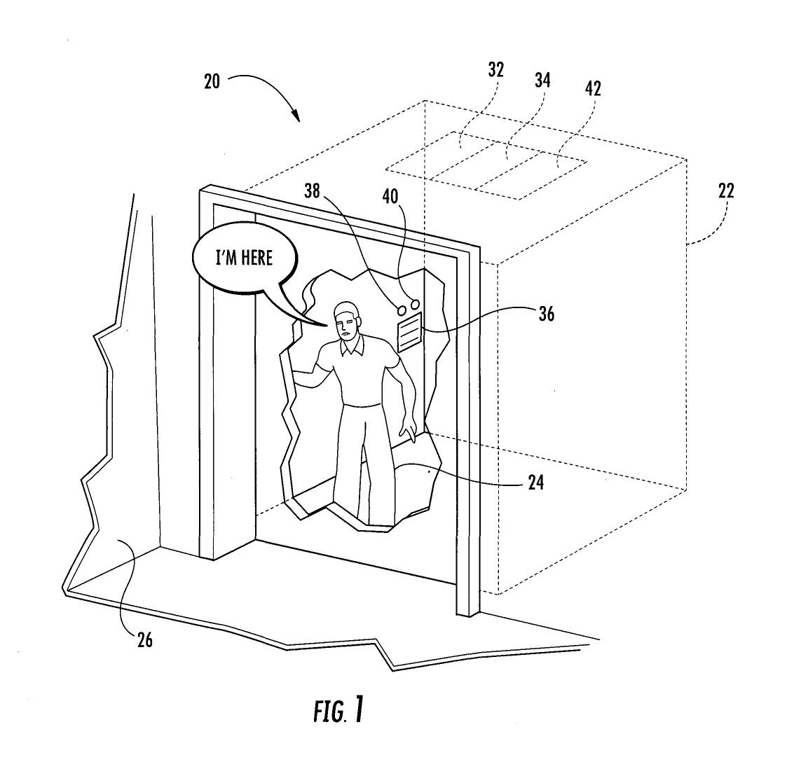

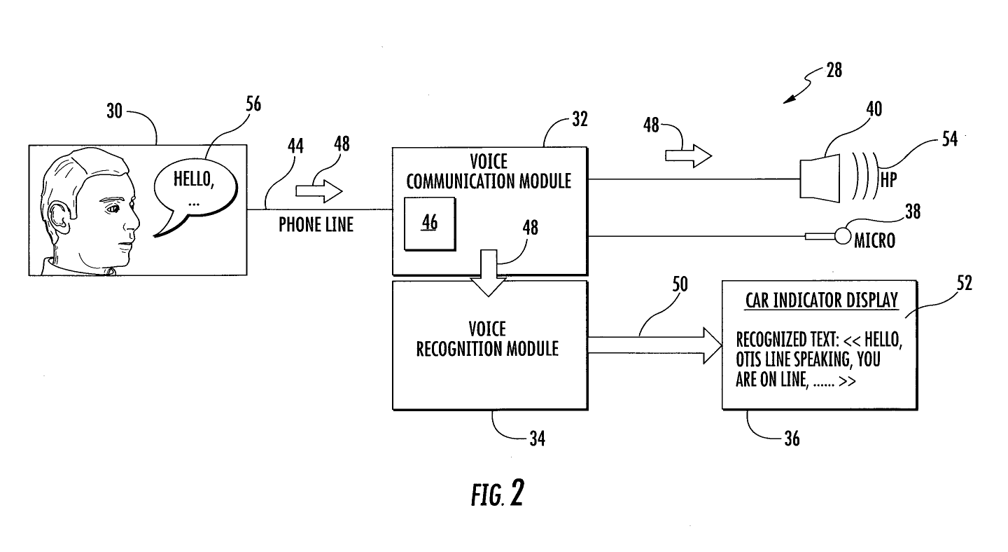

Referring to FIG. 1, an elevator system 20 may include an elevator car 22 for transporting at least one passenger 24 between floors of a building 26. Referring to FIGS. 1 and 2, the elevator system 20 may include a visual communication system 28 that may facilitate communication between a source 30 remotely located from the elevator car 22 and the passenger 24. The system 28 has both visual and audible attributes to assist the visually and/or hearing impaired passenger(s) 24. Such assistance may be particularly useful during an unusual event where egress from the elevator car 22 may be delayed. The remote source 30 may be a human being as one, non-limiting, example. The source may also be an on-line service including multiple attendants. An example of such a service is OTISLINE®, by Otis Elevator Company, Hartford, Conn.

The visual communication system 28 may include the source 30, a voice communication module 32, a voice recognition module 34, a visual display or screen 36, a microphone 38 and a speaker 40. The display 36, the microphone 38 and the speaker 40 are located in the elevator car 22 for interaction by the passenger 24. The voice communication module 32 and the voice recognition module 34 may be supported by the elevator car 22 (i.e., travels with the elevator car). In case of an unusual event such as, for example, a power outage, the system 28 may include a back-up power supply or source 42 such as, for example, a battery.

Because the source 30 is located remotely from the elevator car 22 and may be located remotely from the building 26, a line or path 44 may provide two-way communication between the source 30 and the passenger 24 via at least the voice communication module 32. The path 44 may include wired and/or wireless paths. Non-limiting examples of wired paths 44 may include paths that pass through the internet, local area network equipment, and other networks. Non-limiting examples of wireless paths may include cellular telephone network paths, local area network paths, and others.

The source 30 may include an attendant or first responder who is alerted of what may be an unusual event associated with the elevator system 20. An example of an unusual event may be a power outage in the building 26. An alert of the event to the source 30 may occur in any variety of ways or communication channels. Such channels may be part of the visual communication system 28, or separate therefrom. Examples of an alert means may be through the OTISLINE® system, and/or the passenger 24 may initiate the alert by pressing an emergency button (not shown) in the elevator car 22, or by some other actuation. Upon an alert, an auto dialer 46 of the voice communication module 32 may connect communications via path 44 and between the source 30 and the voice communication module 32.

The voice recognition module 34 may be any variety of modules known in the art, and may include a computer processor for converting a voice communication signal (see arrow 48) received from the voice communication module 32 into a text message signal 50 transmitted to the display 36. The display 36 may be a led, plasma or other type of screen capable of visually displaying a text message 52 indicative of the text message signal 50, and may further be interactive and/or a touch screen for interaction by the passenger 24. An interactive display 36 capable of initiating a response to the source 30 may be useful for the hearing impaired and/or those passengers with speech impediments.

The speaker 40 may be a redundant means of audibly broadcasting the first voice communication signal 48 as an audible voice message 54. The audible voice message 54 may be particularly useful for sight impaired passengers 24 not capable of reading the text message 52. Alternatively, headphones as an example of a speaker 40 may be useful for the hearing impaired passengers 24 for receiving the first voice communication signal 48.

The voice communication module 32, the voice recognition module 34, the display 36, the microphone 38 and the speaker 40 may be packaged together as one unit (e.g. supported by a common housing). Alternatively various components may be separate from one-another with a plurality of communication paths and power lines routed there between.

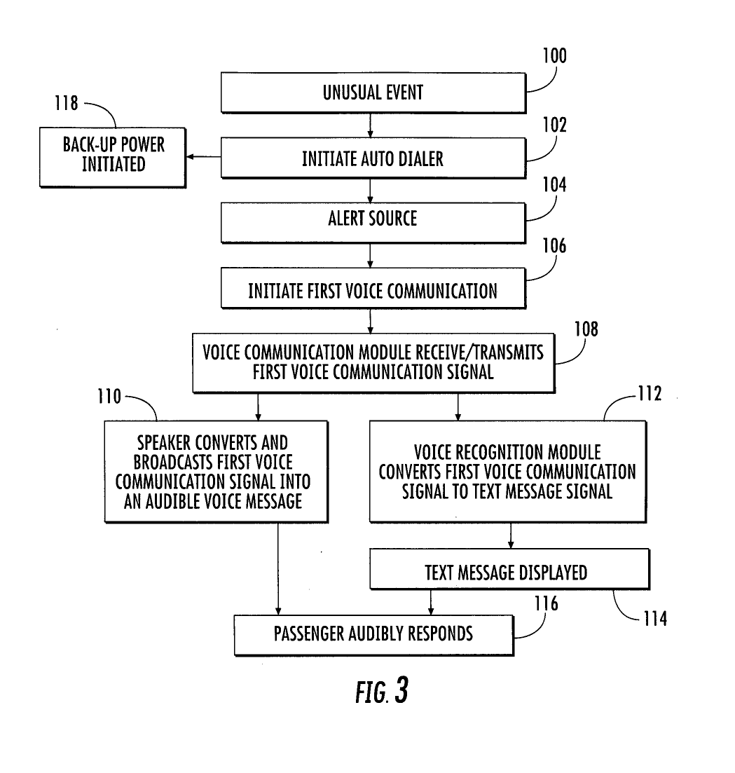

Referring to FIGS. 2 and 3, a method of operation of the voice communication system 28 is generally illustrated. As a first step or event 100, an unusual event may occur that causes a passenger 24 (who may be hearing impaired) to become trapped within the elevator car 22 of the elevator system 20. As step 102, this unusual event may initiate the auto dialer 46 of the communication module 32. As step 104, the auto dialing (or other means) may alert the source 30. As step 106, the source 30 may be a human attendant who may speak a first voice communication 56 into a phone system that transmits the first voice communication 56 (e.g., an audible signal) as a first voice communication signal 48 (e.g., an electronic or electrical signal). As step 108, the voice communication module 32 receives the first voice communication signal 48 and may transmit the signal to both the speaker 40 and the voice recognition module 34. As step 110, the speaker 40 converts and broadcasts the first voice communication signal 48 into the audible voice message 54. Simultaneously to step 110, a step 112 includes the conversion of the first voice communication signal 48 into the text message signal 50; and, step 114 includes transmitting the text message signal 50 to the display 36 for displaying as the text message 52.

When the passenger 24 hears the voice message 54 and/or reads the associated text message 52, as step 116, the passenger 24 may audibly respond to either message 52, 54 by speaking into the microphone 38 which transmits a response signal 58 through the voice communication module 32, through the path 44 and to the source 30. As yet another step 118 (and one that may occur at any time), the normal power source of the elevator system and thus the voice communication system 28 may fail due to the unusual event. In such a case, the back-up power source (e.g. battery) may provide electrical power to the communication module 32, the recognition module 34 and the display 36.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. A visual communication system for an elevator car of an elevator system comprising:
a voice recognition module configured to recognize a first voice communication originating from a source remotely located from the elevator car, and generate a text message; and
a text display disposed in the elevator car and configured to visually display the text message indicative of the first voice communication.

2. The visual communication system set forth in claim 1, wherein the source is a human being.

3. The visual communication system set forth in laim 1 further comprising:
a battery for providing power to the text display and the voice recognition module.

4. The visual communication system set forth in claim 1 further comprising:
a voice communication module configured to receive the first voice communication from the source and transmit to the voice recognition module.

5. The visual communication system set forth in claim 4 further comprising:
a speaker located in the elevator car and configured to receive the first voice communication from the voice communication module and audibly transmit the first voice communication into the elevator car.

6. The visual communication system set forth in claim 4 further comprising:
a microphone located in the elevator car and configured to receive a second voice communication from a passenger in the elevator car and transmit the second voice communication to the source.

7. The visual communication system set forth in claim 4, wherein the voice recognition module and the voice communication module are carried by the elevator car.

8. The visual communication system set forth in claim 4, further comprising:
a wireless phone line facilitating transmission of the first voice communication from the source to the voice communication module, and wherein the voice communication module includes an auto dialer configured to initiate communications.

9. The visual communication system set forth in claim 4, further comprising:
a battery for providing back-up power to the text display, the voice recognition module, and the voice communication module.

10. The visual communication system set forth in claim 4, further comprising:
a speaker located in the elevator car and configured to receive the first voice communication from the voice communication module and audibly transmit the first voice communication into the elevator car;
a microphone located in the elevator car and configured to receive a second voice communication from a passenger in the elevator car and transmit the second voice communication to the source; and
a communication line facilitating transmission of the first and second voice communications between the source and the voice communication module, and wherein the voice recognition module is carried by the elevator car.

11. The visual communication system set forth in claim 4, wherein the voice communication module is carried by the elevator car.

12. The visual communication system set forth in claim 10, further comprising:
a battery constructed and arranged to provide back-up power to the text display, the voice recognition module, and the voice communication module.

13. A method of operating a visual communication system for an elevator car of an elevator system comprising:
producing a first voice communication by a source located remotely from the elevator car;
converting the first voice communication to a text message;
displaying the text message on a display in the elevator car; and
reading of the text message by the passenger.

14. The method set forth in claim 13, wherein an initiation of an unusual event causes undesirable confinement of a passenger in the elevator car.

15. The method set forth in claim 13, further comprising:
audibly transmitting the first voice communication into the elevator car.

16. The method set forth in claim 13, further comprising:
speaking a second voice communication by the passenger in response to the text message;
receiving the second voice communication by a microphone in the elevator car; and
transmitting the second voice communication to the source.

17. The method set forth in claim 16, wherein the first and second voice communications are electronically transmitted via a voice communication module.

18. The method set forth in claim 13, wherein the first voice communication is generated into the text message via a voice recognition module.

19. The method set forth in claim 18 further comprising:
providing back-up power to the display, the voice communication module, and the voice recognition module by a battery.

20. The method set forth in claim 14, further comprising:
auto dialing a communication link between the source and the passenger upon occurrence of the unusual event.
